(19) United States
(12) Patent Application Publication
(10) Pub. No.: US 2010/0050028 A1
(43) Pub. Date: Feb. 25, 2010

(54) NETWORK DEVICE AND METHOD FOR SIMULTANEOUSLY CALCULATING NETWORK THROUGHPUT AND PACKET ERROR RATE

(75) Inventor: SHAO-MING KUO, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/388,520

(22) Filed: Feb. 19, 2009

(30) Foreign Application Priority Data
Aug. 20, 2008 (CN) 200810304079.1

(51) Int. Cl. G06F 11/00

(52) U.S. Cl. 714/704; 714/E11.004

(57) ABSTRACT

A network device and a method simultaneously calculates network throughput and packet error rate of a device under test (DUT). The network device, communicating with a server via the DUT, transforms TCP data packets to IP data packets, transmits the IP data packets to the server via the DUT, records size of total number of the TCP data packets, time cost for transmitting the TCP data packets to the server, and a first number of the IP data packets transmitted by the network device, and obtains a second number of the IP data packets that are received by the server. The network device further calculates the network throughput of the DUT according to the size and the time, and calculates the packet error rate of the DUT according to the first number and the second number of the IP data packets.

### BACKGROUND

1. Technical Field

Embodiments of the present disclosure relate to network communications, and more particularly to a network device and method for calculating network throughput and packet error rate.

2. Description of Related Art

Performance parameters of most devices are required to be tested. For example, network throughput and packet error rates of wireless network adapters or network gateways are required to be calculated. The network throughput is usually calculated via a transmission control protocol (TCP) but it is difficult to calculate the packet error rate via TCP because TCP data packets will be retransmitted if the TCP data packets are dropped and hence an erroneous number of packets will be counted. Usually, the packet error rate is calculated using the user datagram protocol (UDP). However, one must use TCP to calculate the throughput and separately use UDP to measure the packet error rate.

Therefore, a heretofore unaddressed need exists to simultaneously calculate the network throughput and the packet error rate to overcome the aforementioned deficiencies and inadequacies.

### BRIEF DESCRIPTION OF THE DRAWINGS

The details of the present disclosure, both as to its structure and operation, can best be understood by referring to the accompanying drawings, in which like reference numbers and designations refer to like elements.

FIG. 1 is a schematic diagram of one embodiment of an application environment and functional modules of a network device for simultaneously calculating network throughput and packet error rate of the present disclosure; and

FIG. 2 is a flowchart of another embodiment of a method for simultaneously calculating network throughput and packet error rate in accordance with the present disclosure.

### DETAILED DESCRIPTION OF CERTAIN INVENTIVE EMBODIMENTS

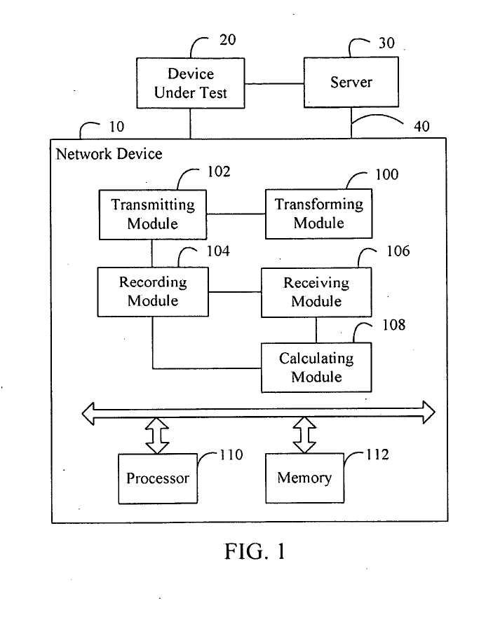

A schematic diagram of one embodiment of an application environment and functional modules of a network device 10 of the present disclosure is shown in FIG. 1. The network device 10 is typically a programmed general-purpose computer system, such as a personal computer, a workstation, a server system, a minicomputer, or a mainframe computer. The network device 10 includes a processor 110 and a memory 112. The processor 110 is operable to execute computer program instructions in order to carry out the functions of the network device 10. The memory 112 is operable to store computer program instructions executable by the processor 110.

The network device 10 connects a server 30 and transmits data to the server 30 via a device under test (DUT) 20 according to transmission control protocol and Internet protocol (TCP/IP). In this embodiment, the network device 10 further connects the server 30 by way of a wired network 40, such as an ethernet network. In another embodiment, the network device 10 may only connects the server 30 via the DUT 20. The DUT 20 may be a network adapter, a router, or a switch, among other adapters. The server 30 may be a programmed general-purpose computer system.

The network device 10 is configured for simultaneously calculating network throughput and packet error rate of the DUT 20. The packet error rate of the DUT 20 is equal to (totₜ−totᵣ)/totₜ, where totₜ is the total number of packets transmitted by the network device 10 and totᵣ is the total number of packets received. The network throughput of the DUT 20 is equal to size of total number of the transmitted data packets divided by total transmission time of the data packets, wherein the data packets are transmitted from the network device 10 to the server 30 via the DUT 20 during the transmission time. The size of total number of transmitted data packets may be measured in bytes, kilobytes, or megabytes, for example.

In the embodiment, the network device 10 comprises a transforming module 100, a transmitting module 102, a recording module 104, a receiving module 106, and a calculating module 108.

The transforming module 100 is configured for transforming TCP data packets to IP data packets. The network device 10 and the server 30 both include a TCP layer and an IP layer. When the network device 10 transmits data to the server 30, the data is transmitted from the TCP layer to the IP layer of the network device 10, and then transmitted to the IP layer of the server 30, and finally transmitted to the TCP layer of the server 30.

The transmitting module 102 is configured for transmitting the IP data packets to the server 30 via the DUT 20.

The recording module 104 is configured for recording size of total number of the TCP data packets and time cost for transmitting the TCP data packets to the server 30 via the DUT 20, wherein transmitting the TCP data packets to the server 30 includes transforming the TCP packets to the IP packets and then transmitting the IP packets to the server 30. Each TCP packet is recorded only if the network device 10 received an acknowledge message indicating the server 30 has received the TCP packet. Therefore, the size of total number of the TCP data packets recorded by the recording module 104 is the same as that of total number of the TCP data packets received by the server 30. In this embodiment, the size of total number of the TCP data packets and the time cost for transmitting the TCP data packets to the server 30 is stored in the memory 112.

The recording module 104 is further configured for recording a first number of the IP data packets transmitted by the transmitting module 102. All the data packets transmitted from the IP layer are recorded no matter whether the data packets are received by the server 30 or not. In this embodiment, the first number of the IP data packets is stored in the memory 112.

In the embodiment, the recording module 104 includes a driver program embedded in the IP layer, such as a protocol driver or an IP hook driver. The driver program detects when the IP layer transmits IP data packets via application programming interfaces (APIs). Those APIs may be provided by a computer operating system, such as MICROSOFT WINDOWS. In this embodiment, the driver program detects that the IP layer transmits IP data packets to the server 30, and then detects if source addresses of the IP data packets are the same as an IP address of the network device 10 and if destination addresses of the IP data packets are the same as an IP address of the server 30. If the source addresses of the IP data packets are the same as the IP address of the network device 10, and the destination addresses of the IP data packets are the same as the IP address of the server 30, the recording module 104 concludes that the IP data packets are indeed transmitted to the server 30 by the network device 10. Accordingly, the recording module 104 detects and records the number of the IP data packets transmitted to the server 30 so as to obtain a first number.

In the embodiment, the server 30 also includes a driver program embedded in the IP layer of the server 30. The driver program in the server 30 detects and records the number of IP data packets received by the server 30 to obtain a second number of the IP data packets. If an IP data packet is not successfully transmitted from the network device 10 to the server 30, the network device 10 will retransmit the IP data packet to the server 30. Therefore, the second number of the IP data packets may be less than the first number of the IP data packets.

The receiving module 106 is configured for obtaining the second number of the IP data packets from the server 30. In the embodiment, the receiving module 106 obtains the second number of the IP data packets from the server 30 via the wired network 40.

The calculating module 108 is configured for calculating the network throughput of the DUT 20 according to the size of total number of the TCP data packets and the time cost for transmitting the TCP data packets to the server 30. In the embodiment, the network throughput of the DUT 20 is equal to the size of total number of the TCP data packets divided by the time cost for transmitting the TCP data packets to the server 30.

The calculating module 108 is further configured for calculating the packet error rate of the DUT 20 according to the first number and the second number of the IP data packets. In the embodiment, the packet error rate of the DUT 20 is equal to (n₁−n₂)/n₁, wherein n₁ is the first number of the IP data packets and n₂ is the second number of the IP data packets.

As such, the network device 10 has simultaneously calculated the network throughput and the packet error rate of the DUT 20. Therefore, the network device 10 of the present disclosure may substantially halve the time used for testing the DUT 20.

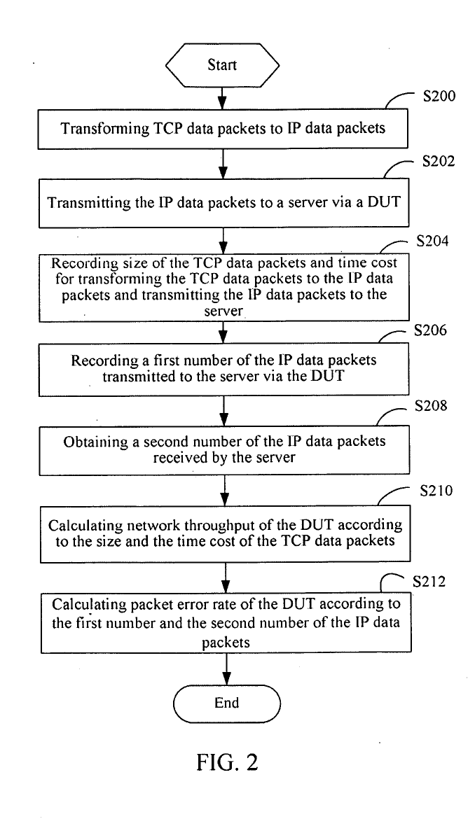

FIG. 2 is a flowchart of another embodiment of a method for simultaneously calculating network throughput and packet error rate in accordance with the present disclosure. As mentioned above, the above method is typically run on a programmed general-purpose computer system, such as a personal computer, a workstation, a server system, or a minicomputer or mainframe computer.

In the embodiment, the method for simultaneously calculating network throughput and packet error rate is performed by the function modules of the network device 10 depicted in FIG. 1. The method for simultaneously calculating network throughput and packet error rate is configured for simultaneously calculating network throughput and packet error rate of the DUT 20. It may be understood that additional steps may be added, others removed, and ordering of the steps may be changed depending on the embodiment.

In step S200, the transforming module 100 transforms TCP data packets to IP data packets. The network device 10 and the server 30 both include a TCP layer and an IP layer. When the network device 10 transmits data to the server 30, the data is transmitted from the TCP layer to the IP layer of the network device 10, and then transmitted to the IP layer of the server 30, and finally transmitted to the TCP layer of the server 30.

In step S202, the transmitting module 102 transmits the IP data packets to the server 30 via the DUT 20.

In step S204, the recording module 104 records the size of total number of the TCP data packets and time cost for transmitting the TCP data packets to the server 30 via the DUT 20, wherein transmitting the TCP data packets to the server 30 includes transforming the TCP packets to the IP packets and then transmitting the IP packets to the server 30. Each TCP packet is recorded only if the network device 10 received an acknowledge message indicating the server 30 has received the TCP packet. Therefore, the size of total number of the TCP data packets recorded by the recording module 104 is the same as that of the TCP data packets received by the server 30.

In step S206, the recording module 104 records a first number of the IP data packets transmitted by the transmitting module 102. All the data packets transmitted from the IP layer are recorded no matter whether the data packets are received by the server 30 or not.

As previously mentioned, the recording module 104 includes a driver program embedded in the IP layer to detect when the IP layer transmits IP data packets via application programming interfaces (APIs). The method to detect the transmission is described above.

As mentioned above, the server 30 also includes a driver program embedded in the IP layer of the server 30 to detect and record number of the IP data packets received by the server 30 to obtain a second number of the IP data packets. If an IP data packet is not successfully transmitted from the network device 10 to the server 30, the network device 10 will retransmit the IP data packet to the server 30. Therefore, the second number of the IP data packets may be less than the first number of the IP data packets.

In step S208, the receiving module 106 obtains the second number of the IP data packets that are received by the server 30. In this embodiment, the receiving module 106 obtains the second number of the IP data packets by the wired network 40, which makes the receiving module 106 correctly obtains the second number of the IP data packets from the server 30.

In step S210, the calculating module 108 calculates the network throughput of the DUT 20 according to the size of total number of the TCP data packets and the time. In the embodiment, the network throughput of the DUT 20 is equal to the size of total number of the TCP data packets divided by the time.

In step S212, the calculating module 108 calculates the packet error rate of the DUT 20 according to the first number and the second number of the IP data packets. In the embodiment, the packet error rate of the DUT 20 is equal to (n₁−n₂)/n₁, wherein n₁ is the first number of the IP data packets and n₂ is the second number of the IP data packets.

As such, the network device 10 has simultaneously calculated the network throughput and the packet error rate of the DUT 20. Therefore, the network device 10 of the present disclosure may substantially halve the time used for testing the DUT 20, and accordingly double the speed of testing the DUT 20.

It is important to note that while the present disclosure has been described in the context of a fully functioning data processing system, those of ordinary skill in the art will appreciate that the processers of the present disclosure are capable of being distributed in the form of a computer readable medium of instructions and a variety of forms and that the present disclosure applies equally regardless of the particular type of signal bearing media actually used to carry out the distribution. Examples of computer readable media include recordable-type media such as floppy disc, a hard disk driver, RAM, or CD-ROM's, as well as transmission type media, such as digital or analog communications links.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

What is claimed is:

1. A network device for simultaneously calculating network throughput and packet error rate of a device under test (DUT), the network device communicating with a server via the DUT according to transport control protocol and Internet protocol (TCP/IP), the network device comprising:
a transforming module configured for transforming TCP data packets to IP data packets;
a transmitting module configured for transmitting the IP data packets to the server via the DUT;
a recording module configured for recording size of total number of the TCP data packets, time cost for transmitting the TCP data packets to the server via the DUT, and a first number of the IP data packets transmitted by the transmitting module;
a receiving module configured for obtaining a second number of the IP data packets that are received by the server;
a calculating module configured for calculating the network throughput of the DUT according to the size of total number of the TCP data packets and the time, and calculating the packet error rate of the DUT according to the first number and the second number of the IP data packets; and
at least one processor that executes the transforming module, the transmitting module, the recording module, the receiving module, and the calculating module.

2. The network device as claimed in claim 1, wherein the packet error rate of the DUT is equal to (n₁−n₂)/n₁, wherein n₁ is the first number of the IP data packets and n₂ is the second number of the IP data packets.

3. The network device as claimed in claim 2, wherein the receiving module obtains the second number of the IP data packets from the server via a wired network.

4. A computer-implemented method for simultaneously calculating network throughput and packet error rate of a device under test (DUT), comprising:
transforming transport control protocol (TCP) data packets to Internet protocol (IP) data packets;
transmitting the IP data packets to a server via the DUT;
recording size of total number of the TCP data packets and time cost for transmitting the TCP data packets to the server via the DUT;
recording a first number of the IP data packets transmitted to the server via the DUT;
obtaining a second number of the IP data packets that are received by the server;
calculating the network throughput of the DUT according to the size of total number of the TCP data packets and the time; and
calculating the packet error rate of the DUT according to the first number and the second number of the IP data packets.

5. The method as claimed in claim 4, wherein the packet error rate of the DUT is equal to (n₁-n₂)/n₁, wherein n₁ is the first number of the IP data packets and n₂ is the second number of the IP data packets.

6. The method as claimed in claim 5, wherein the second number of the IP data packets is obtained from the server via a wired network.

7. A computer-readable medium having computer executable code to cause a computer to perform a method for simultaneously calculating network throughput and packet error rate of a device under test (DUT), the computer communicating with a server according to transport control protocol and Internet protocol (TCP/IP), the method comprising:
transforming TCP data packets to IP data packets;
transmitting the IP data packets to a server via the DUT;
recording size of total number of the TCP data packets and time cost for transmitting the TCP data packets to the server via the DUT;
recording a first number of the IP data packets transmitted to the server via the DUT;
obtaining a second number of the IP data packets that are received by the server;
calculating the network throughput of the DUT according to the size of total number of the TCP data packets and the time; and
calculating the packet error rate of the DUT according to the first number and the second number of the IP data packets.

8. The computer-readable medium as claimed in claim 7, wherein the packet error rate of the DUT is equal to (n₁−n₂)/n₁, wherein n₁ is the first number of the IP data packets and n₂ is the second number of the IP data packets.

9. The computer-readable medium as claimed in claim 8, wherein the second number of the IP data packets is obtained from the server via a wired network.
